(19) United States
(12) Patent Application Publication
(10) Pub. No.: US 2020/0403469 A1
(43) Pub. Date: Dec. 24, 2020

(54) ELECTRIC MOTOR

(71) Applicant: Brose Fahrzeugteile SE & Co. Kommanditgesellschaft, Würzburg, Würzburg (DE)

(72) Inventors: Sunny ZHANG, Eindoven (NL); Thomas SUSEMIHL, Würzburg (DE); Kevin STEINERT, Unterpleichfeld (DE)

(73) Assignee: Brose Fahrzeugteile SE & Co. Kommanditgesellschaft, Würzburg, Würzburg (DE)

(21) Appl. No.: 16/975,770

(22) PCT Filed: Feb. 22, 2019
(86) PCT No.: PCT/EP2019/054403

§ 371 Date: Aug. 26, 2020

(30) Foreign Application Priority Data
Feb. 27, 2018 (DE) 10 2018 202 943.1

(51) Int. Cl. H02K 1/27; H02K 7/14; H02K 21/22; H02K 15/03; B29C 45/17

(52) U.S. Cl. CPC H02K 1/2786; H02K 1/2733; B29C 45/17; H02K 21/22; H02K 15/03; H02K 7/14

(57) ABSTRACT

A brushless electric motor having a stator and having a rotor which is drive-connected to a rotating element, wherein the rotor has a permanent-magnet rotor magnet which is magnetized in the manner of a Halbach arrangement, wherein the rotor magnet is an injection-molded part containing embedded magnetically anisotropic magnet material, which injection-molded part is formed at least partially from a ferrite, and wherein the rotor is integrated into the rotating element or is joined to said rotating element.

### CROSS-REFERENCE TO RELATED APPLICATIONS

This application is the U.S. National Phase of PCT Application No. PCT/EP2019/054403 filed on Feb. 22, 2019, which claims priority to German Patent Application No. DE 10 2018 202 943.1, filed on Feb. 27, 2018, the disclosures of which are hereby incorporated in their entirety by reference herein.

### TECHNICAL FIELD

The present disclosure relates to a brushless electric motor.

### BACKGROUND

A brushless electric motor typically includes a rotor which is mounted rotatably against a fixed stator. For example, the stator in this case has a rotating field winding by means of which a magnetic rotating field is generated when an alternating current is applied to it. The rotor in this case comprises permanent magnets, the magnetic field whereof interacts with the rotating field of the stator, so that the rotor is driven in a rotary manner.

### SUMMARY

One or more problems addressed by this disclosure may be specifying an electric motor with an improved magnetic flux flow between the rotor and the stator of the electric motor and improved flux flow susceptibility. In addition, this electric motor may be produced in a cost-saving manner.

According to one or more embodiments, a brushless electric motor is provided. The electric motor may include a stator and a rotor which is drive-connected to a rotating element. The rotor in this case may include a permanent-magnetic rotor magnet (ring magnet) which is magnetized in the manner of a Halbach array. This rotor magnet is an injection-molded part with embedded magnetically anisotropic magnetic material, wherein the magnetically anisotropic magnetic material is formed at least in part from a ferrite. The magnetically anisotropic magnetic material is also referred to simply as the magnetic material below. Furthermore, the rotor is integrated in the rotating element or joined thereto.

The rotor magnet has Halbach magnetization with a number of magnetic poles. This magnetization may be achieved by means of magnetic prealignment during production of the magnet. For example, the rotor magnet in this case has 6 to 20 magnetic poles, or 8 to 20 magnetic poles, or for example 10 to 20 magnetic poles.

The magnetically anisotropic magnetic material may be plastic-bonded. The plastic in this case is a binding material in which magnetically anisotropic, such as powdered, magnetic material is embedded. A plastic such as nylon, polyphenlyene sulfide or polyamide, for example, is used as the binding agent for this purpose.

As an example, the ferrite is a hard ferrite. By way of example, as an alternative to ferrite a magnetically anisotropic alloy of neodymium iron boron (NdFeB) is used as the magnetic material. A magnet with ferrite as the magnetically anisotropic magnetic material is, however, comparatively cost-saving and more temperature-resistant than a magnet with an alloy of neodymium iron boron.

In order to join the rotor to the rotating element, a joining contour or joining elements such as screw bosses or hot-clamping bosses, for example, may be provided. This is, or these are, formed on the rotor magnets such as by means of a multi-component injection-molding method.

Consequently, the rotor magnet and the joining contour or joining elements provided for joining are integrally formed. The rotor is therefore producible, and also produced, in a single production step and may be in the finished shape provided for, which advantageously saves on further production steps and production costs. By comparison with a rotor which is produced from individual components and therefore has a comparatively high tolerance chain in the assembly state of the individual components, in the case of the rotor integrally configured by means of the multi-component injection-molding process, a tolerance chain of this kind is comparatively small, which is why the running properties and acoustics of the electric motor are improved.

In addition or alternatively, the rotor may be formed in such a manner by means of the injection-molding process that it exhibits ventilation holes which may be run in the axial direction in respect of a motor axle. In this way, an air flow over a motor mount supporting the electric motor is made possible. This air flow is used for cooling motor electronics arranged in or on the motor mount, for example. Furthermore, in the case of a rotor formed by means of the injection-molding process, no rotor laminations are required, which is why costs may be reduced, the weight of the rotor is reduced and a comparatively high (torque) density of the (motor) torque acting on the rotor by means of the rotating field is achieved.

For example, additionally or alternatively, a rotor in the form of an inner rotor is annularly configured by means of the injection-molding process. In other words, the (coreless) rotor configured as an inner rotor has a central recess. A rotor of this kind is then effectively joined to the rotating element by means of the joining contour or by means of the joining elements. The rotating element in this case is rotatably mounted in a corresponding manner, for example by means of a bearing shaft of a motor mount. Advantageously, an installation space is provided on account of this recess, said installation space being used for cooling or electronics, for example, and/or facilitating alternative designs for cooling channels.

In summary, the injection-molding process means that the geometry of the rotor and, the rotor magnet is comparatively easily adaptable, and adapted, to requirements resulting from the installation space and/or predefined functionality, such as the ventilation holes for example.

In a suitable embodiment, the rotor magnet has a remanence of between 0.2 T and 0.5 T at room temperature (20° C.) and a coercive field strength of the magnetic polarization (Ha) of between 150 kA/m and 1000 kA/m.

In addition, the rotor has on its side facing the stator a sinusoidal flux density pattern. In this case, a maximum flux density (flux density amplitude) of between 1.2 times and 1.5 times the remanence of the rotor magnet is achieved. On the side opposite this side, the flux density is substantially equal to zero. In other words, the rotor magnet exhibits magnetization in the manner of a Halbach array, such that the maximum flux density on the circumference of the rotor reaches 1.2 times to 1.5 times the remanence. The (magnetic) flux density amplitude of the sinusoidal profile pattern of the magnetic flux density may be between 0.32 T and 0.7 T.

In summary, the rotor magnetized in the manner of a Halbach array has on its side facing the stator and, accordingly, in an air gap formed between the rotor and the stator, a sinusoidal magnetic field pattern in relation to a radial direction, in other words perpendicular to the motor axle. This results in a sinusoidal electromagnetic force (EMF) along the circumferential direction of the rotor. As an example, due to the production of the rotor by means of injection-molding and the correspondingly superimposed magnetization, a sinusoidal EMF is achieved in this case without, or at least with comparatively few, and/or weakly formed harmonic components. On account of this, a comparatively small torque ripple and a comparatively small iron loss occur, which is why the motor efficiency is advantageously improved. The running properties of the electric motor are therefore improved. In addition, the sinusoidal shape of the magnetic field strength pattern reduces a cogging torque of the rotor. Furthermore, a radial force which acts on the stator teeth is thereby reduced, so that deformation of the stator and an associated deterioration in motor acoustics is avoided.

In summary, the magnetic flux flow between the rotor and the stator of the electric motor and the flux flow susceptibility thereof are improved.

The motor torque acting on the rotor by means of the rotating field is proportionate to the square of the diameter of the rotor. In other words, the motor torque therefore increases with the rotor diameter. According to another embodiment, the rotor is configured as an outer rotor. Consequently, the motor torque is greater in this way by comparison with an electric motor configured as an inner rotor based on the same size of electric motor.

Furthermore, when the rotor is embodied as an outer rotor, integration thereof in the rotating element is made easier, insofar as the rotating element incorporates the rotor and the stator on the outside in the radial direction and/or is arranged there.

In order to integrate the rotor in the rotating element, according to one or more embodiments the rotor and the rotating element are an injection-molded part configured in one piece (integrally). As an example, the injection-molded part is produced in a multi-component injection molding process for this purpose. The rotor is not therefore drive-connected to the rotating element by means of a shaft, but drives the rotating element immediately (directly) in a rotating manner about the motor axle during the rotation thereof.

The advantages referred to in connection with the embodiment in which the joining contour, or the joining elements, and the rotor magnet are integrally configured apply here analogously. Hence, in this case the rotor and the rotating element are of one-piece design, which saves on production costs and improves the running properties of the electric motor. Furthermore, the rotating element is, by way of example, configured with an integrated rotor by means of the multi-component injection-molding method, in such a manner that the rotor and/or the rotating element have ventilation holes.

According to one or more embodiments, the rotating element is mounted in a rotating manner with the integrated rotor via a bearing system on the bearing shaft of the motor mount. In this case, the stator is attached (held, fastened) to the engine mount. In a suitable embodiment, the rotating element is the hub of a fan wheel. In this way, the hub may include the bearing system. In addition, the rotor is formed on the inside of the hub. A hub of this kind suitably incorporates the rotor and the stator on the outside with respect to the radial direction. Consequently, integration of the rotor configured as an outer rotor on the inside of the hub enclosing the outer rotor can be achieved comparatively easily.

### BRIEF DESCRIPTION OF THE DRAWINGS

Exemplary embodiments of the invention are explained in greater detail below with the help of a drawing. In the drawing:

FIG. 1 shows in a schematic representation the field line pattern of a magnetic field between a rotor magnet of a rotor and a stator of an electric motor, and the rotor is configured as an outer rotor and exhibits magnetization in the manner of a Halbach array,

FIG. 2 shows schematically in a sectional depiction a hub of a fan with a bearing system, and the rotor configured as an outer rotor is integrated in the hub and by means of the bearing system, the hub and the rotor are mounted in a rotating manner on a bearing shaft of a motor mount,

FIG. 3 shows schematically an alternative embodiment of the electric motor in which the rotor configured as an inner rotor is joined to the hub of the fan,

FIG. 4a shows schematically as a sectional depiction a second alternative embodiment of the electric motor, in which the rotor magnet of the rotor configured as an outer rotor is joined to a rotor pot, and

FIG. 4b shows in plan view the rotor magnet of the rotor according to FIG. 4a, and the rotor magnet has a number of shoulders and pin-like studs for joining to the rotor pot.

Parts which correspond to one another are provided with the same reference numbers in all figures.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Permanent magnets are generally produced from a powder of a magnetic material, such as a neodymium alloy or a ferrite, by means of a sintering process. The normal magnetization of the permanent magnets in this case is achieved during the production thereof by means of an applied exciter magnetic field. The permanent magnets are then introduced into the rotor, said permanent magnets being arranged in spoke form, for example, in the rotor. In summary, this kind of production of the permanent magnets takes place in a comparatively time-consuming manner and is therefore cost-intensive. In addition, on account of the multi-part design of the rotor and/or the production of the rotor in multiple steps, the total tolerance of the rotor is comparatively high, which has a detrimental effect on the motor statics and acoustic performance of the motor.

As an alternative to the spoke-shaped arrangement of the permanent magnets (magnetic segments) of the rotor, rotors are used, for example, which are magnetized in the manner of a Halbach array (Halbach magnetization). With an array of this kind, the magnetic field is stronger on one side of the array, while it is weaker on the opposite side. In this case, with corresponding orientation of the permanent magnets, a sinusoidal field strength pattern is produced on the side facing the stator, as a result of which the cogging torque is reduced. On the other hand, on the side opposite this side the field strength is substantially equal to zero, so that no magnetic return is necessary.

For this purpose, the rotors are produced in the corresponding orientation with Halbach magnetization by means of individually prefabricated, anisotropic permanent magnets, for example. As an alternative to this embodiment with multiple anisotropic permanent magnets, Halbach magnetization can be achieved by means of an isotropic ring magnet on which the Halbach magnetization is superimposed.

Hence, for example, a rotor with a rotor magnet which is formed from multiple ring magnet segments produced using an injection molding process is known from DE 10 2013 007 563 A1. In this case, in the assembly state the rotor magnet has Halbach magnetization with a plurality of magnetic poles on the circumference. In this case, the ring magnet segments are made of a magnetically anisotropic magnetic material which is exposed to a correspondingly formed magnetic field during the injection-molding process, in order to achieve the anticipated magnetization.

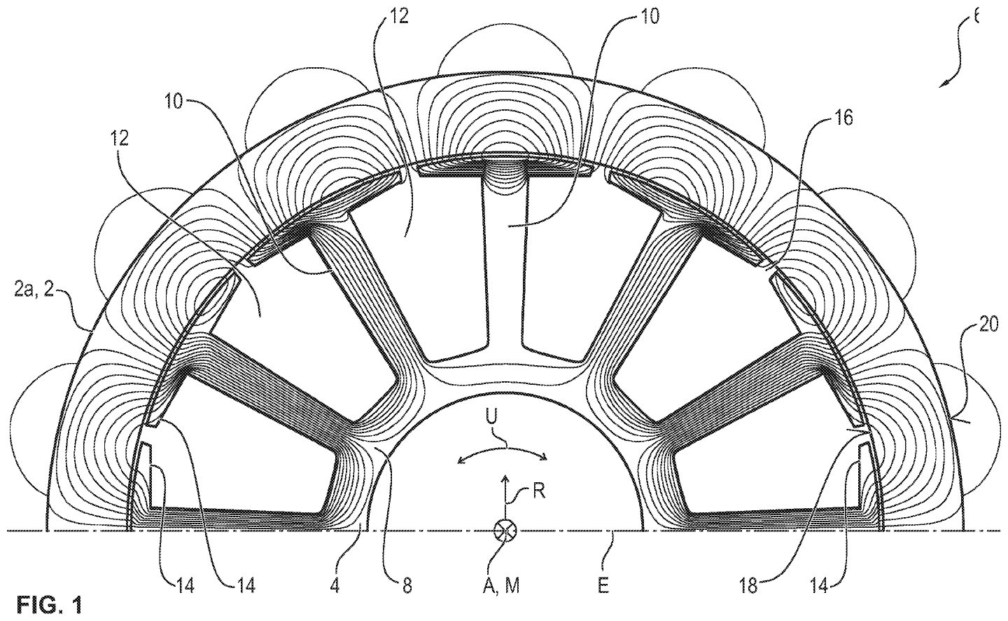

FIG. 1 shows schematically a field line pattern of a magnetic field between a rotor magnet 2a of a rotor 2 which is rotatably mounted about a motor axle M extending in the axial direction A, and a stator 4 of a brushless electric motor 6. In this case, these are only depicted sectionally for the purpose of improved visibility of the field line pattern. Hence, FIG. 1 shows only half of the rotor 2 and of the stator 4, and the half of the rotor 2 and of the stator 4 which are not depicted is mirror-symmetrical in respect of a plane E through which the motor axle M runs and which is oriented perpendicularly to the drawing plane.

The stator 4 has an annular stator yoke 8, from which stator teeth 10 extend away from the motor axle M to the rotor 2 in a star-shape, so in a radial direction R oriented perpendicularly to the axial direction A. The rotor 2 is therefore arranged on the outside of the stator 4. In other words, the rotor 2 is configured as an outer rotor.

Stator grooves 12 are formed between the stator teeth 10, in which a stator winding (not depicted) may be formed by coils, is received. The stator teeth in this case are T-shaped. Hence, they are extended at their free end facing the rotor 2 on both sides, forming pole tabs 14 in a circumferential (azimuthal) direction which is oriented perpendicularly to the axial direction A and to the radial direction R.

The rotor magnet 2a is magnetized in the manner of a Halbach array. For this purpose, the rotor magnet 2a is configured as an injection-molded part in which magnetically anisotropic magnetic material is embedded, and the magnetic material is formed at least in part from a ferrite. In this case, the rotor magnet has fourteen magnetic poles. Due to the Halbach magnetization, the magnetic field lines are guided substantially within the rotor 2. Consequently, no iron return is necessary for the rotor 2. On the other hand, a magnetic return in the stator 4 takes place through the stator yoke 8.

The magnetic field lines are oriented substantially along the radial direction R in a/an (air, motor) gap 16 formed between the rotor 2 and the stator 4. The magnetic field in this case exhibits a sinusoidal flux density pattern along the circumference of the rotor 2, so in the circumferential direction U, on the (inner) side 18 thereof facing the stator 4, while on the side 20 opposite this side, so the outer side, the flux density is substantially equal to zero. As an example, the rotor magnet has a remanence of 0.28 T and a coercive field strength of the magnetic polarization (H_{cJ}) of 200 KA/m. The choice of magnetic material, the density thereof in the rotor magnet 2a, the number of poles, and the magnetization orientation make it possible for the maximum flux density to be 1.2 to 1.5 times the remanence.

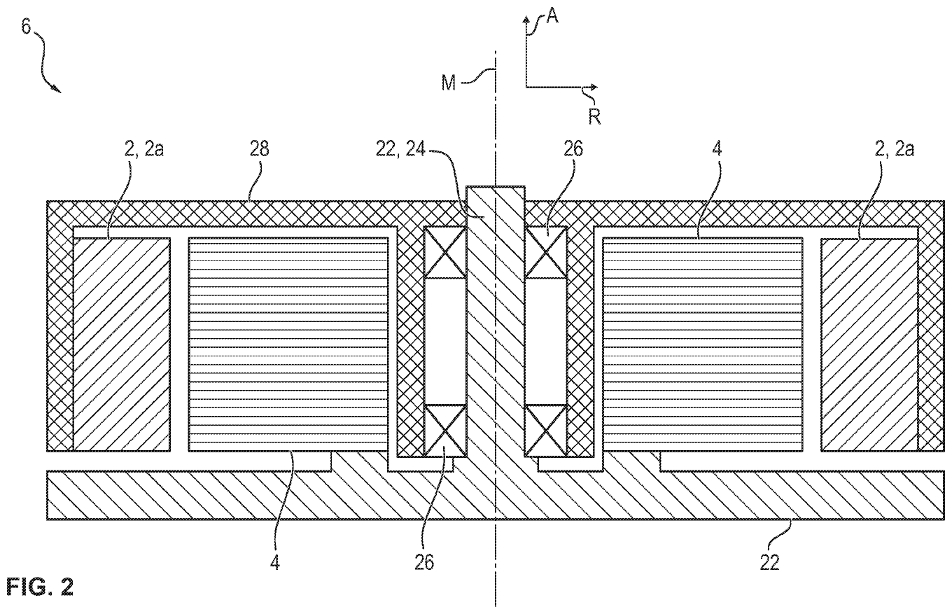

FIG. 2 shows the electric motor 6 as a schematic sectional depiction, and the sectional plane is spanned by means of the axial direction A and by means of the radial direction R, and the motor axle lies in this sectional plane. The stator 4 in this case is fastened or attached to a motor mount 22. The motor mount 22 has a bearing shaft 24 extending centrally in the axial direction A. By means of a bearing system 26, a rotating element 28 is mounted rotatably about the motor axle M. In this case, the rotating element 28 may include the bearing system 26 or is formed at least by part by means thereof. The rotating element 28 is configured as a hub of a fan wheel.

The rotor 2 in this case is integrated in the rotating element 28. For this purpose, the rotor 2 and the rotating element 28 are an injection-molded part configured in one-piece (monolithically). For this purpose, the rotating element 28 is produced with the rotor 2 integrated in this manner by means of a multi-component injection-molding process. The hub in this case incorporates the rotor 2 on the outside. In other words, in order to integrate the rotor 2 in the rotating element 28, the rotor 2 is formed on the inside 30 of the rotating element 28, i.e. on the side facing the stator 4 and running perpendicularly to the radial direction R. In this way, the rotor 2 is drive-connected to the rotating element 28 formed as the hub of the fan wheel.

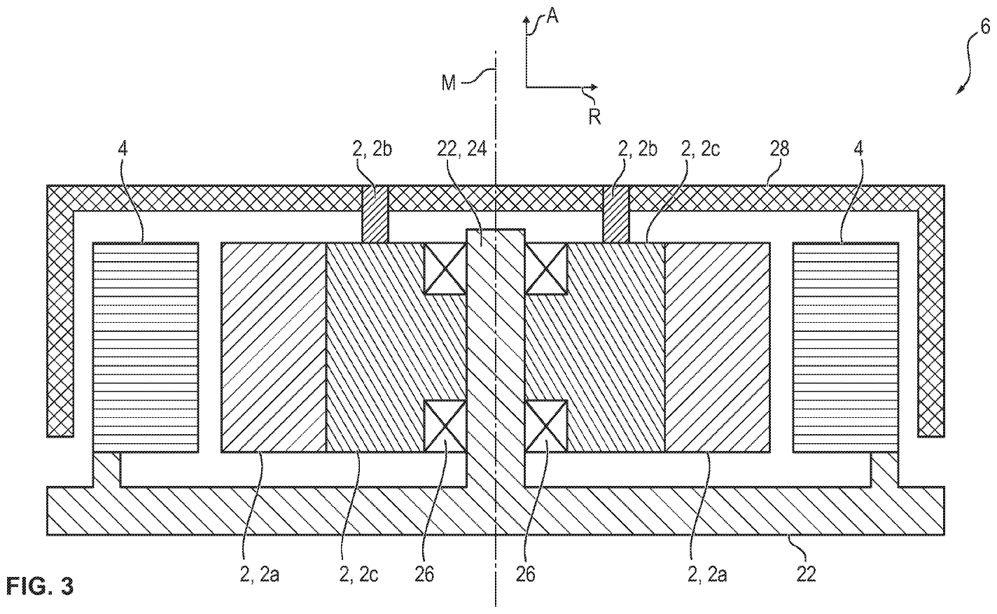

An alternative embodiment of the electric motor 6 is depicted in FIG. 3, in which the rotor 2 is configured as an inner rotor. Similarly to the embodiment according to FIG. 2, the stator 4 is attached to the motor mount 22, and the motor mount 22 may include the bearing shaft 24 extending in the axial direction A centrally.

By comparison with the embodiment in FIG. 2, in which the rotating element 28 configured as a hub is mounted on the bearing shaft 24 by means of the bearing system 26, the rotor 2 in this case has a rotor core 2c which incorporates the bearing system 26 or forms it at least in part. By means of the bearing system 26, the rotor 2 is rotatably mounted on the bearing shaft 24 of the motor mount 22. The annular rotor magnet 2a in this case incorporates the rotor core on the outside with respect to the radial direction R. The hub of the fan wheel in this case is joined to the rotor 2 by means of the joining elements 2b thereof. For example, the joining elements 2b are configured as screw bosses, such as molded on during production of the rotor 2 by means of the multi-component injection-molding process, or as detent contours or as a pin-shaped joining contour which is joined during the course of hot pressing or hot caulking to a corresponding contour of the hub.

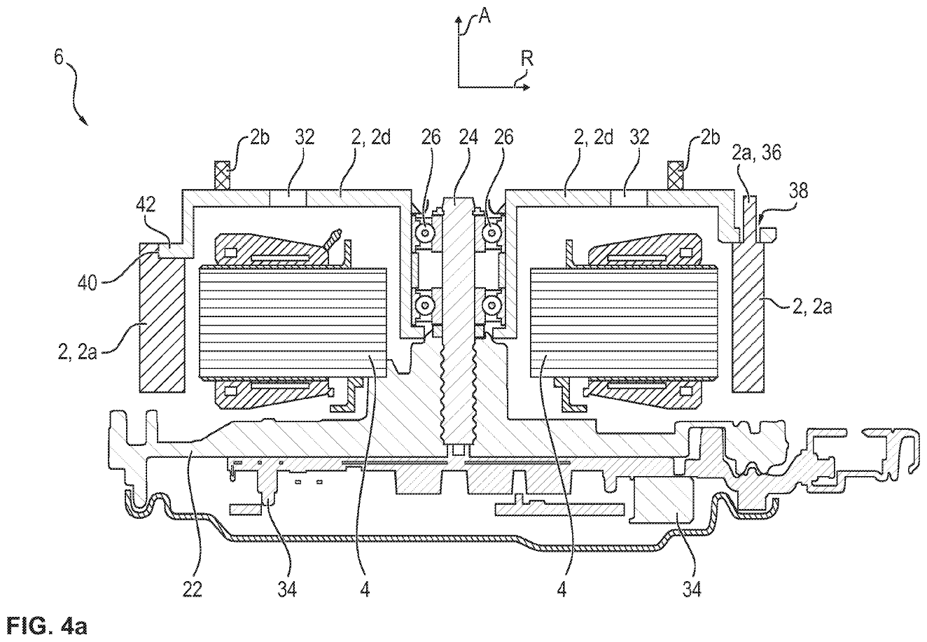

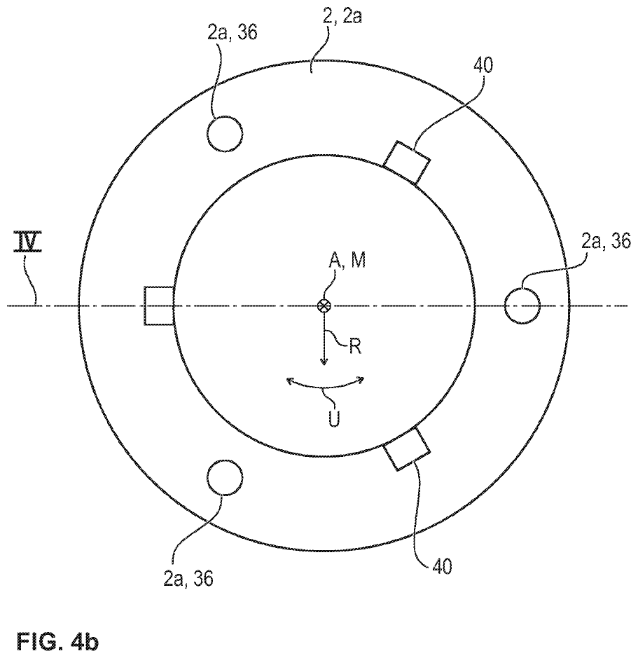

FIG. 4a shows a second alternative embodiment of the electric motor 6, and the rotor 2 is configured as an outer rotor. The rotor magnet 2a of the rotor 2 in this case is mounted rotatably by means of a rotor pot 2d via the bearing system 26 on the bearing shaft 24. The rotor pot 2d in this case is an injection-molded part, for example, or, alternatively, a component produced by milling, and aluminum may be used as the material for the rotor pot 2d. In addition, the rotor pot has continuous recesses 32 in the axial direction which are each realized by means of a bore, for example. This produces an air flow (draft) for cooling the stator 4 or the (motor) electronics 34 arranged on the motor mount 22. The rotor top 2d has joining elements 2b for joining to the rotating element 28 not depicted in greater detail, which in this case are configured as screw bosses, for example.

As shown in FIG. 4b, the rotor magnet 2a has joining pins 36 to join it to the rotor pot 2d, which joining pins sit in corresponding receiving means 38. For example, the joining pins are held on the side facing away from the rotor magnets 2a by means of a retaining ring not depicted in further detail or, alternatively, joining takes place by means of laser welding or hot caulking. In summary, the rotor magnet 2a is joined by means of the rotor pot 2d to the rotating element 28 which is not depicted in further detail.

In order to balance out play between the joining pin 36 and the corresponding receiving means and achieve a secure hold of the magnet in the tangential direction (azimuthal, in the circumferential direction U), the rotor 2a has a cuboid-shaped recess forming abutment shoulders 40, in which recess a tab 42 of the rotor pot sits in a form-fitting manner with respect to the radial direction R and the circumferential direction U. The plane IV represents the sectional plane according to FIG. 4a.

The invention is not limited to the exemplary embodiments described above. Instead, other variants of the invention can also be derived therefrom by the person skilled in the art, without departing from the subject matter of the invention. In particular, all individual features described in connection with the exemplary embodiments can, in addition, also be combined with one another in this way, without departing from the subject matter of the invention.

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.

### LIST OF REFERENCE NUMBERS

2 Rotor
2a Rotor magnet
2b Joining element
2c Rotor core
2d Rotor pot
4 Stator
6 Electric motor
8 Stator yoke
10 Stator tooth
12 Stator groove
14 Pole tab
16 Gap
18 Inside of the rotor
20 Outside of the rotor
22 Motor mount
24 Bearing shaft
26 Bearing system
28 Rotating element
30 Inside of the rotating element
32 Recess
34 Electronics
36 Joining pin
38 Receiving means
40 Abutment shoulder
42 Tab
A Axial direction
E Plane of symmetry
M Motor axle
R Radial direction
U Circumferential direction

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A brushless electric motor comprising:
a stator,
a rotor including an injection-molded part and a permanent-magnet rotor magnet formed by magnetically anisotropic magnetic material magnetized to form a Halbach array, wherein the anisotropic magnetic material is at least partially formed by ferrite; and
a rotating element integrally formed to the injection-molded part or connected to the rotor so that the rotor drives the rotating element.

2. The brushless electric motor of claim 1,
wherein
the permanent-magnet rotor magnet has a remanence ranging between 0.2 T and 0.5 T and a coercive field strength of the magnetic polarization (H_{cJ}) ranging between 150 kA/m and 1000 kA/m.

3. The brushless electric motor claim 2,
wherein
the rotor includes a first side facing the stator and a sinusoidal flux density pattern is formed along a circumference of the first side, wherein the sinusoidal flux density pattern has a maximum flux density ranging between 1.2 times and 1.5 times the remanence. and

4. The brushless electric motor of claim 1,
wherein
the rotor is an outer rotor configured to rotate about the stator.

5. The brushless electric motor of claim 4,
wherein
the rotor and the rotating element are each injection-molded and integrally formed together.

6. The brushless electric motor of claim 5,
further comprising:
a bearing shaft attached to the stator; and
a bearing system arranged on the bearing shaft and forming a motor mount, wherein the rotating element is rotatably mounted to rotor by the bearing system.

7. The brushless electric motor of claim 6,
wherein
the rotating element is a hub of a fan wheel, wherein the hub includes the bearing system and the rotor is disposed within an inner portion of the rotating element.

8. The brushless motor of claim 3, wherein the rotor includes a second side opposing the first side, and the second side has a flux density and wherein the flux density is substantially equal to zero.

9. A brushless motor comprising:
a motor mount;
a bearing shaft extending from the motor mount;
a stator supported by the motor mount;
a rotating element including an inner portion and an outer portion, wherein the inner portion is disposed on the bearing shaft; and
a rotor disposed between the outer portion of the rotating element and the stator, wherein the rotor includes,
a rotor core formed of plastic and integrally formed to the rotating element, and
a permanent magnet formed by anisotropic magnetic material magnetized to form a Halbach array, wherein the anisotropic magnetic material is embedded in at least portions of the rotor core.

10. The brushless motor of claim 9, wherein the rotating element is formed by a fan wheel hub.

11. The brushless motor of claim 9, further comprising a joining element extending from the rotor core into an aperture defined by the rotating element.

12. The brushless motor of claim 9, further comprising a bearing element at least partially disposed in the rotor core and engaged with the bearing shaft.

13. The brushless motor of claim 9, wherein the anisotropic magnetic material is neodymium iron boron (NdFeB).

14. A brushless motor comprising:
a motor mount;
a bearing shaft extending from the motor mount;
a rotor pot having a W-shaped cross section including an inner portion and an outer portion, wherein the inner portion is configured to rotate about the bearing shaft;
a stator disposed between the motor mount and the rotor pot; and
a rotor magnet fixed to the outer portion of the rotor pot, wherein the rotor magnet is formed by a magnetically anisotropic magnetic material magnetized to form a Halbach array.

15. The brushless motor of claim 14, wherein the outer portion includes a tab and the rotor magnet defines an aperture that receives the tab.

16. The brushless motor of claim 15, wherein the recess engages the tab to form a form fit condition.

17. The brushless motor of claim 16, wherein the bearing shaft is configured to rotate about a rotational axis and the tab extends in a direction substantially orthogonal to the rotational axis.

18. The brushless motor of claim 14, further comprising:
a joining pin extending from the rotor magnet, wherein the outer portion of the rotor pot defines an aperture that receives the joining pin.

19. The brushless motor of claim 14, wherein the rotor pot has a W-shaped cross section.

20. The brushless motor of claim 19, wherein the stator is supported by the motor mount.
